(19) United States
(12) Patent Application Publication
(10) Pub. No.: US 2002/0163878 A1
(43) Pub. Date: Nov. 7, 2002

(54) CD-O-NUT adapter for mini compact disks

(76) Inventors: Nicola Hulme, Santa Barbara, CA (US); Steve Karman, Los Angeles, CA (US)

Correspondence Address: Nicola Hulme, 920 E. HALEY STREET, SANTA BARBARA, CA, 93103, US

(21) Appl. No.: 09/848,378

(22) Filed: May 2, 2001

(51) Int. Cl. G11B 3/70; G11B 5/84; G11B 7/26

(52) U.S. Cl. 369/289

(57) ABSTRACT

A universal adapter for mini compact disks of any shape to render them acceptable in any disk drive, having a thin, flat, circular base (10) with a circular hole (14) in the center encircled by a narrow shelf (12) which supports a mini disk.

### CROSS REFERENCE TO RELATED APPLICATIONS

Not applicable

### BACKGROUND

1. Field of Invention

This invention relates to compact disks, specifically to an adapter for mini compact disks.

### BACKGROUND

2. Description of Prior Art

Mini compact disks come in many shapes and forms, including business card compact disks, shaped mini compact disks, and circular mini compact disks. The problem is accordingly they are not compatible with disk drives that only accept 12 cm diameter, circular compact disks, such as the common front loading disk drives. In an attempt to solve this problem, Business Replication & Print, Inc. of Roseville, Calif. have developed an adapter called a ‘halo disk’. These adapters are custom made for each shaped mini compact disk and are therefore only useful for a specific shape, rendering them expensive to make and having limited versatility.

### SUMMARY

A universal adapter comprises a circular sheet of flat material with a means for holding any style of mini compact disk in the center, thereby making them compatible with any disk drives.

### Objects and Advantages

Accordingly, several objects and advantages of the invention are:

a) to provide the means to use mini compact disks and mini shaped compact disks in front loading disk drives

b) to provide a universal adapter which can be used with all mini compact disks, business card disks, mini shaped compact disks

c) to provide a low cost attractive adapter to widen the appeal of novelty mini compact disks.

Further objects and advantages are to provide an adapter that can be used easily and conveniently to hold mini compact disks without damage to a disk drive or the disk, which is simple to use and easy to manufacture, which can be used repeatedly. Still further objects and advantages will become apparent from a consideration of the ensuing description and drawings.

### DRAWING FIGURES

In the drawings closely related figures have the same number but different alphabetical suffixes.

FIGS. 1A and 1B show top and underside views of our adapter.

FIGS. 2A and 2B show side views of our adapter including a mini compact disk.

FIGS. 3A and 3B show perspective views of our adapter also including a mini compact disk.

FIGS. 4A and 4B are perspective views of our adapter showing layers and a mini compact disk.

### REFERENCE NUMERALS IN DRAWINGS

10 base of adapter

12 shelf

14 hole

16 top layer

18 bottom layer

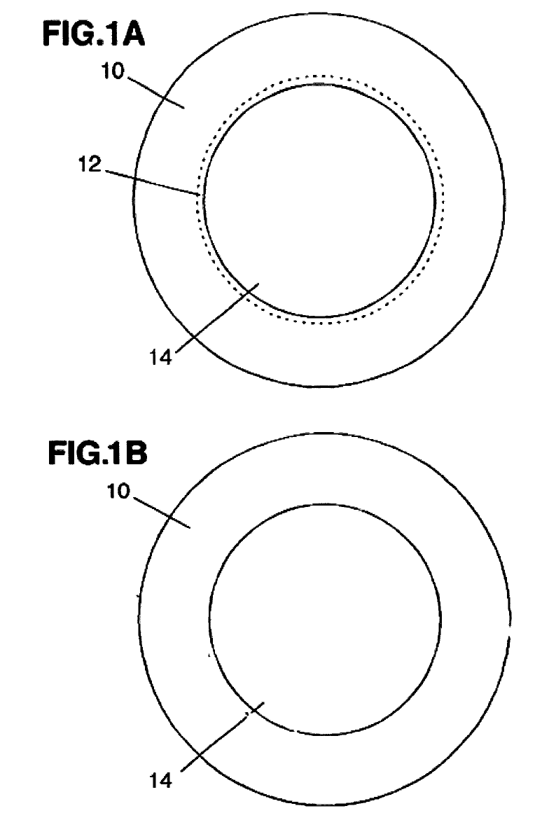

### DESCRIPTION-FIGS. 1-3-PREFERRED EMBODIMENT

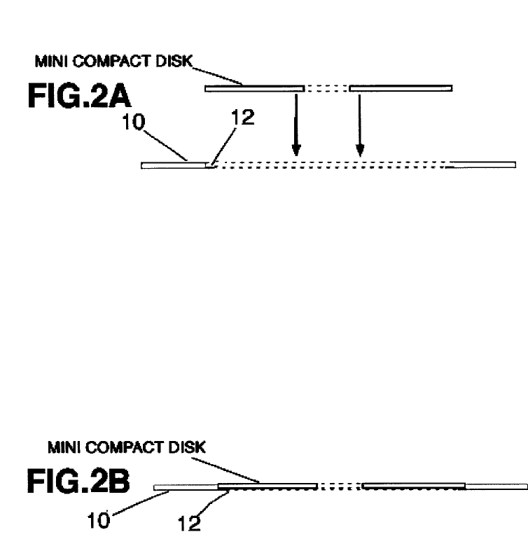

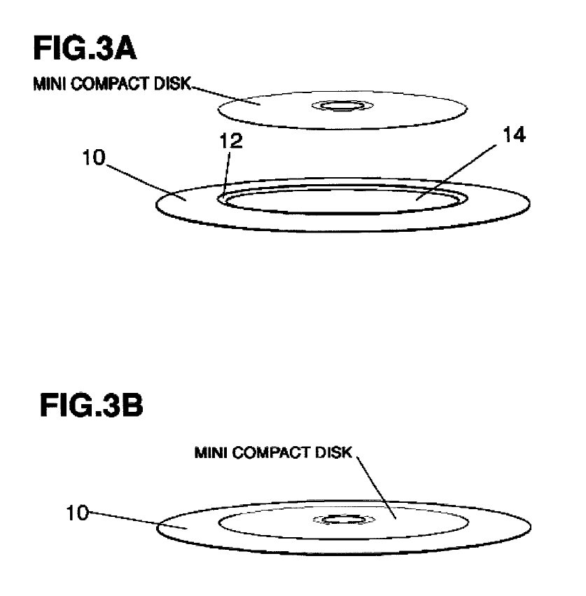

A preferred embodiment of the adapter of the present invention is illustrated in FIG. 1A (top view), FIG. 1B (underside view). The adapter has a base 10 of 0.15 cm thickness consisting of a flat, non-magnetic sheet of material such that it can withstand repeated use in a disk drive. Said base 10 has a predetermined parameter of 12.0 cm. In the preferred embodiment, the base is constructed of polycarbonate with a lacquer layer and a label laminated on top surface. However, the base can consist of any other non-magnetic material that is strong enough to support a mini compact disk in a disk drive. A narrow shelf 12 encircles a central hole 14 in base 10, with a diameter of 8.0 cm, which is the width of a mini compact disk. A mini compact disk can be placed from above on shelf 12 (FIGS. 2A and 2B) to be supported by base 10 of the adapter. FIGS. 3A and 3B show how a mini compact disk lies in hole 14 supported by shelf 12.

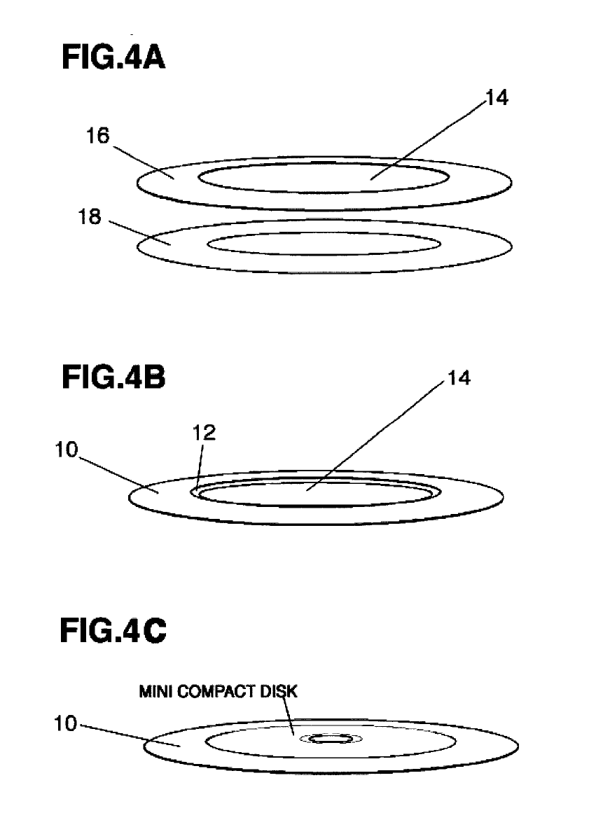

### FIGS. 4A-4C-ALTERNATIVE EMBODIMENT

There are various possibilities with regard to the manufacture of the adapter. FIG. 4A shows an exploded view with a top layer 16 and a bottom layer 18. Layer 16 has a central hole 14 with a diameter of 8.0cm. Layer 18 has a central hole with a smaller diameter. Thus when the layers are adhered together, layer 18 protrudes to create shelf 12 (FIG. 4B). A mini disk fits into hole 14 to lie flush with the surface of the adapter (FIG. 4C).

### Operation-FIGS. 1-4

To use the adapter a mini compact disk is placed horizontally in the center of base 10 where it is supported by shelf 12. The mini compact disk is then held in place by the edges of hole 14 and can be safely inserted into a front loading disk drive. The mini compact disk lies flush with base 10 and is therefore accepted by the disk drive as a standard 12 cm diameter compact disk. The hole 14 in base 10 allows the mini compact disk to be scanned from the bottom.

### Conclusion, Ramifications, and Scope

Accordingly, the reader will see that the adapter of this invention can be used to make mini compact disks more appealing to the end user by allowing them to be used in any type of disk drive where previously they could only be used in tray disk drives. The adapter works equally well with shaped mini compact disks as the shelf can support any protruding edges. The adapter can also be made with a ‘clicking’ device to hold the mini compact disk in place, rather than using a shelf.

Although the description above contains many specifications, these should not be construed as limiting the scope of the invention but as merely providing illustrations of some of the presently preferred embodiments of this invention. For example, the adapter can be made of alternative materials; it can also be made within a limited range of thicknesses. Thus the scope of the invention should be determined by the appended claims and their legal equivalents, rather than by the examples given.

We claim:

1. An adapter for hosting mini compact disks comprising a thin, flat, circular piece of material having a diameter of 12 cm with a circular hole in the center having a diameter of approximately 8 cm with a narrow shelf around circumference of said hole to support outer edges of a mini compact disk, whereby a mini compact disk can be accepted by a disk drive.

2. An adapter for hosting mini compact disks comprising a thin, flat circular piece of material having a diameter of 12 cm with a means to hold a mini compact disk in the central hole, whereby a mini compact disk can be accepted by a disk drive.

3. A universal adapter capable of holding a mini disk of an infinite number of variable shapes within a circular piece of material having a diameter of approximately 12 cm, whereby a mini disk can be loaded into a disk drive.
